(19) United States
(12) Patent Application Publication
(10) Pub. No.: US 2024/0131611 A1
(43) Pub. Date: Apr. 25, 2024

(54) PROCESS FOR SPOT WELDING WITH ADDITION OF MATERIAL

(71) Applicant: VALDIR FURLANETTO, SAO PAULO (BR)

(72) Inventor: VALDIR FURLANETTO, SAO PAULO (BR)

(21) Appl. No.: 18/466,877

(22) Filed: Sep. 13, 2023

(30) Foreign Application Priority Data
Oct. 18, 2022 (BR) 102022021265-1

(51) Int. Cl. B23K 11/11

(52) U.S. Cl. CPC B23K 11/115

(57) ABSTRACT

A process for spot welding with addition of material to join metal sheets which comprises a process of spot welding that uses material deposited on one of the sheets with the welding interface between the areas of sheet to be joined, in order to avoid marks or indentation, with the surface cavities caused by the welding process, so that they are invisible after welding, surface treatment or painting; the process includes making the deposition of the material before welding on one of the sheets with any welding processes or also use of any additive manufacturing processes.

### FIELD OF THE INVENTION

The present invention has as its object a practical and innovative process for spot welding with addition of material belonging to the field of spot welding, of use more precisely to join metal sheets.

The process was developed with a view to eliminating the punctate surface deformations that appear after the process of spot weld, which are inherent to this type of welding, widely used in automotive, aeronautical, aerospace, railway, naval, petrochemical, oil, gas, white line, household items, electro electric industry, boiler shop and sheet metal in general.

It is, therefore, a process developed to offer an improved final finish, combined with great productive efficiency in manufacturing lines in general.

Also, the purpose of the present invention, present a process for spot weld with the addition of material with low costs for its industrial application, but allied to the requirements of efficiency, safety, and practicality, thus offering the consumer public, an additional option in the market of counterparts, which unlike the processes of traditional spot weld, offers numerous possibilities and benefits to its users, becoming a process of great acceptance in the consumer market.

In the process of resistance spot weld (RSW), the overlapping parts to be welded are pressed against each other by means of electrodes moved by forces: mechanical, pneumatic, hydraulic or a mixture of them. Then a short pulse of low voltage and high current is supplied and passes through the electrodes, not consumables, through the base material. The resistance of this base material to the passage of current causes an amount of heat on the contact surfaces of the parts proportional to time, electrical resistance and current intensity, which should be sufficient to allow this region to reach the melting point of the material, forming a molten region that receives the name of spot weld (Metals Handbook, 1983).

When the current flow ceases, the force of the electrodes is still maintained while the weld metal quickly cools and solidifies. The electrodes are retracted after each spot welded. The area through which the welding current passes, the shape and diameter of the weld points generated are limited by the diameter and contour of the electrode face (Metals Handbook, 1983).

The electrical resistance at the interface between the parts is usually in the range of 50 to 500 μOhms, but it can be as low as 20 μOhms for aluminum, requiring current with intensity between 5000 A and 100,000 A for fusion to occur, which also depends on the conductivity thermal of the metal involved, which is relatively small for steel and high for aluminum, for example. The voltages employed range from 1 to 20 V, very rarely reach 30 V, with the current application time ranging from less than 0.01 s for sheets (very thin sheets) to varies seconds for thicker parts (Machado, 1996).

The processes of spot weld in vehicle bodies and applications in general, leave permanent marks, such as cavities, even after the painting process and in the case of the automobile industries, these visible marks, are located mainly on the inside of the doors, trunk lid, hood, etc., this phenomenon being called indentation.

Indentation occurs when the compressive resistance of the material in contact with the electrode decreases as the fusion progresses, thus allowing the face of the electrode to move into the surface of the part. This indentation can be large when an electrode with a small surface area is employed with excessively high pressure and current density that also impairs the aesthetic aspect of the surface of the work, can decrease the mechanical strength of welding. Wu (1968).

### DESCRIPTION OF THE STATE OF THE ART

Much has been done to solve the undesirable phenomenon of indentation resulting from the technique of spot welding. In this aspect and to specify the state of the art, some patent documents that deal with over processes with the same conceptual purposes can be cited, but without achieving the inventive merit and the differentials now revealed, as follows.

The patent document BR 1020160042321 reveals a welding process to the point that leaves no mark or indentation on the sheets.

After welding, which is notable for using a metal pellet, made of metals or alloys of metal or of solid metal or metal alloys, which is introduced between the interfaces of the sheets to be welded by the spot welding process, being the metal insert positioned, on the base sheet, by inert adhesive or other material and process that does this function, and during the melting process, the metal insert merges and dilutes with the base material, that is, the opposing metal sheets; it is emphasized that the alloy of the metal insert has the chemical and physical properties compatible with the properties of the base metal sheets, the spot welding equipment requires its contact electrodes to have the totally flat surfaces and or special contact geometry.

The patent document US2008102308 reveals a method for joining an iron member and an aluminum member, the iron member including a veneered layer at least on one side of union with the aluminum member; the aluminum member formed from an aluminum coating material including a core material of aluminum formed mainly of aluminum and a layer of aluminum alloy with a melting point lower than that of the aluminum core material, coated on one side of union with the iron member; the method including a step of stacking the iron member and the aluminum member, and a step of joining the iron member and the aluminum member.

### Deficiencies of the State of the Art

The major drawback of the process described in the patent document BR 1020160042321 shows that the process to make, position and glue the insert before welding requires substantial time and labor, which results in great loss of productivity and consequently high cost of production.

Another aspect of this process is the difficulty of automation (positioning and gluing the insert) for a high-volume production.

In turn the method revealed in patent document US2008102308 as described above is a method where the metal sheets to be welded are previously coated with a thin layer of aluminum material, so that the spot welding is assisted by them in the melting of the metal sheets.

Such integral coating of a thin layer of aluminum throughout the length of the metal sheets that will be welded only in small spots implies excessive cost, in addition to this process being complex and time-consuming, causing a large waste of aluminum, even if this coating is very thin.

### DESCRIPTION OF THE INVENTION

In order to obtain a welding to a spot that does not produce visible marks or indentation on the welding sheets, after the process of union, they took the inventors, people linked to the field, with notable sectoral knowledge, to create and develop the object of this patent which idealizes a technique that includes depositing material, in the place corresponding to welding, on the inner face of one of the sheets, before the process of joining them, in order to prevent the electrodes from penetrating the sheets leaving a permanent mark, which are inherent to this type of welding process to the spot, in which not even just the mechanical and functional qualities were considered in the design of its implementation, but also the welding performance and economy in the production process that, correctly applied, brought an increase in efficiency without entailing any burden.

The innovation applied to the spot weld process in question comprises in making deposition of material in one of the sheets, with any welding processes or also using any processes of additive manufacturing, replacing the insert mentioned in document BR 1020160042321 entitled spot weld process with metallic insert.

The material deposited in one of the sheets when welded together with the sheets, merges, and dilutes to the base material that prevents indentation formation in the welding area, with positive results in the surface finish, that is, the spot weld is not visible in the welded surfaces.

Compared to the object of the patent BR 1020160042321 the material deposition method, in presentation, makes the welding process more efficient, gaining faster process and easier automation of it.

It is presented in this description, a practical and innovative process for spot weld with the addition of material with all functional qualities, designed and developed according to the most modern techniques, thus enabling its most varied use, such as in the automotive, aeronautical, aerospace, railway, naval, petrochemical, oil and gas, white goods, household items, electronics industry, boiler shop and sheet metal in general.

And to understand how the process in at issue is extremely simple in its applicability, being therefore easy to feasibility, however, excellent practical and functional results are obtained, offering an innovative technical solution on the traditional process of spot welding.

### DESCRIPTION OF THE DRAWINGS

To complement the present description to obtain a better understanding of the characteristics of the present invention and according to a preferential practical realization of it, accompanies the description, in annex, a set of drawings, where, in an exemplified way, although not limiting if it represented the following:

FIG. 1—Shows an isometric view of a sheet that received the material before welding.

FIG. 2—Shows a view in lateral perspective of a sheet that received the material before welding.

FIG. 3—Shows an isometric view of two sheets prepared for welding, where one of the sheets can be seen with the added material.

FIG. 4—Shows a side view of two sheets moments before they are subjected to the welding process with addition of material.

FIG. 5—Shows a perspective view of the electrodes, whose geometries of the contact faces are planned or special, used in the process for spot weld with addition of material.

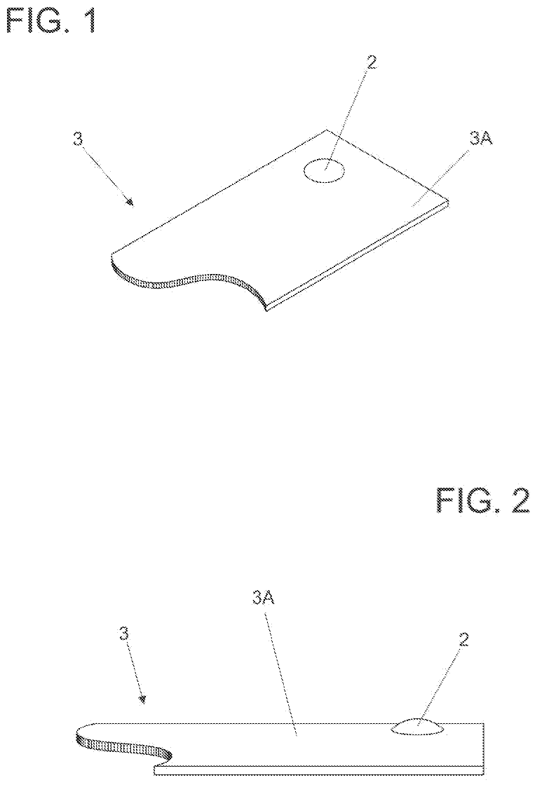

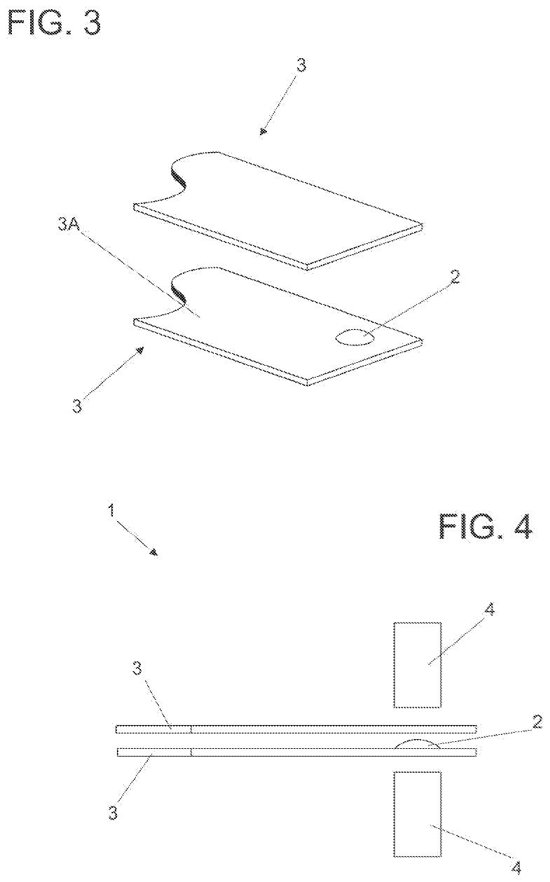

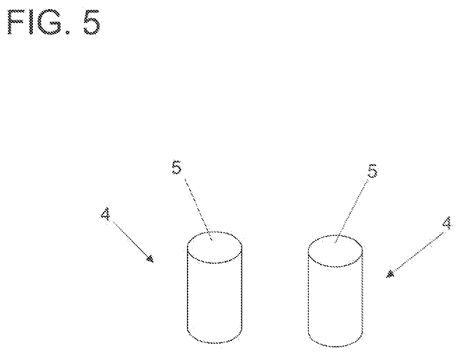

### DETAILED DESCRIPTION OF THE INVENTION

In accordance with the figures listed above, the object of this invention, conceives a process of resistance spot welding (1) which uses material (2) deposited on one of the sheets (3) as a welding interface between the areas of sheet (3) to be joined in order to avoid marks or indentation, such as surface cavities caused by the welding process, so that they are invisible after welding, surface treatment or painting.

The case (1) comprises in, before spot welding, deposition the material (2) at the place corresponding to welding on the inner face (3A) of one of the sheets (3) with any welding processes, or optionally also use any additive manufacturing processes.

The area, thickness and composition of the material deposited (2) on one of the sheets (3) are specified in accordance with the base material to be welded. The equipment for welding and the same used in spot weld by traditional RSW, however, the contact terminals or electrodes (4) that make pressure over the areas of the sheets (3) to be welded, instead of having the rounded contact faces, now have totally flat contact faces (5) and or contact geometry special.

The chemical compositions of the deposited materials (2) are compatible with the properties of the sheets (3) to be welded.

During the melting process, the deposited material (2) melts and dilutes together with the base material, the metal sheets (3) opposed. The deposited material (2) has chemical and physical properties compatible with the properties of the sheets base metallic.

It is certain that when the present invent if put into practice, modifications may be made to certain details of construction and form, without this implying departing from the fundamental principles which are clearly substantiated in the framework claimed. It is thus understood that the terminology used had the purpose of description and not limitation.

1. A process for spot welding with addition material consisting of making the deposition of material in the place corresponding to welding,
on the inner face of one of the sheets,
with any welding processes,
before spot welding.

2. Process for spot welding with addition material, according to claim 1,
characterized by optionally the addition of material can be effected by any additive manufacturing processes.

3. Process for spot welding with additional material, according to claim 1,
characterized by the fact that the area, thickness and composition of the material deposited on one of the sheets are specified in accordance with the base material to be welded.
